(19) United States
(12) Patent Application Publication
(10) Pub. No.: US 2017/0038769 A1
(43) Pub. Date: Feb. 9, 2017

(54) METHOD AND SYSTEM OF DIMENSIONAL CLUSTERING

(71) Applicants: SHOHEI HIDAKA, NONOICHI (JP); NEERAJ KASHYAP, San Jose, CA (US)

(72) Inventors: SHOHEI HIDAKA, NONOICHI (JP); NEERAJ KASHYAP, San Jose, CA (US)

(21) Appl. No.: 15/221,419

(22) Filed: Jul. 27, 2016

Related U.S. Application Data
(60) Provisional application No. 62/197,501, filed on Jul. 27, 2015.

(51) Int. Cl. G05B 19/4155

(52) U.S. Cl. CPC G05B 19/4155; G05B 2219/32169

(57) ABSTRACT

In one example aspect, a method useful for increasing the processing speed of clustering numerical data includes the step of obtaining a data set. The data set includes one or more vector data points of the same dimension. The method includes the step of determining a set of local pointwise dimensional properties over the points in data set. The method includes the step of clustering the data set based on the local fractal dimensional properties. The method includes the step of using the local fractal dimensional properties of the clusters to classify a set of new data points. The set of new data point are generated by the same dynamical or stochastic process as the original data set.

### CROSS-REFERENCE TO RELATED APPLICATIONS

This application is a claims priority to U.S. provisional patent application No. 62/197,501, titled METHOD AND SYSTEM OF DIMENSIONAL CLUSTERING and filed on Jul. 27, 2017. These provisional and utility applications are hereby incorporated by reference in their entirety.

### BACKGROUND

1. Field

This application relates generally to the computer processing of numerical data, and more particularly to a system, method and article of manufacture of dimensional clustering.

2. Related Art

Existing techniques for the estimation of fractal dimensions may not provide access to local dimensional characteristics of the generating system. Accordingly, new method which estimates the pointwise dimensions of the generating system of a given data set can improve data analysis.

### BRIEF SUMMARY OF THE INVENTION

in one example aspect, a method useful for increasing the processing speed of clustering numerical data includes the step of obtaining a data set. The data set includes one or more vector data points of the same dimension. The method includes the step of determining a set of local pointwise dimensional properties over the points in data set. The method includes the step of clustering the data set based on the local fractal dimensional properties. The method includes the step of using the local fractal dimensional properties of the clusters to classify a set of new data points. The set of new data point are generated by the same dynamical or stochastic process as the original data set.

### BRIEF DESCRIPTION OF THE DRAWINGS

FIG. 1 illustrates a process of dimensional clustering, according to some embodiments.

FIG. 2 illustrates an example process of mode identification, according to some embodiments.

FIG. 3 illustrates an example process modal assessment, according to some embodiments.

FIG. 4 depicts an exemplary automated mode analyzer that can be configured to perform any one of the processes provided herein.

FIG. 5 depicts computing system with a number of components that may be used to perform any of the processes described herein.

FIG. 6 illustrates an example computerized system for implementing an online social network, according to some embodiments.

FIG. 7 illustrates an example process for increasing the speed of processing clustered data, according to some embodiments.

The Figures described above are a representative set, and are not an exhaustive with respect to embodying the invention.

### DESCRIPTION

Disclosed are a system, method, and article of manufacture of dimensional clustering. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Behavioral modes can be conditions under which a data generator produces data, and conditions in particular which can be differentiated from one another using the characteristics of the data generated by the data generator under each of them.

Cluster can be a set of data points/objects grouped in such a way that data points/objects in the same group (e.g. a cluster) are more similar (in some sense or another) to each other than to those in other groups.

Data generator can be any system (for example, a mechanical or biological or virtual system) which produces data and from which data can be collected through the use of, for example, a sensor.

Dimensional clustering can be a technique of cluster analysis based upon the estimation of local dimensions around the points in a data set. Additional information regarding dimensional clustering is provided infra.

Distinct behavioral components of a dynamic or stochastic process: Dynamic or stochastic component sub-processes of the larger dynamic or stochastic process such that sufficiently large sets of points generated by each component sub-process display observably different mathematical characteristics when compared with sufficiently large sets of points generated by any other component sub-process.

Exponential distribution can be a statistical distribution (specified by a positive real number parameter \lambda) over the set of positive real numbers such that, when a point is sampled according to this distribution, the probability of it being between two positive real numbers a and b (where a is smaller than b) is ê{−\lambda a}−ê{−\lambda b}.

Probability vector can be a vector with non-negative entries that add up to one.

Recommendation system can be a system which suggests to its user a course of action that the user may take. This course of action may, for example, pertain to how the user may interact with a given data generator and be suggested on the basis of the analysis of data generated by the data generator in question. A recommender can be a recommendation system.

User can be an entity defined in relation to a system, which intends to make use of the system to perform a task of its (the user's) choosing.

Exemplary Methods

In some embodiments, dimensional clustering techniques can detect distinct dynamical components of the generating process of a data set by identifying clusters of data points with similar dimensional characteristics. Dimensional clustering is concerned with using data to make inferences about the nature of the (e.g. generally unknown) process by which the data were generated. In particular, dimensional clustering yields information about the latent modes of operation or behavior of this generating process. Once such modes have been identified, they may be used to assess subsequent data and these assessments can then form the basis for predictions regarding future behavior of the data generator as well as related phenomena.

Among various use cases illustrated herein, dimensional clustering can be applied in image processing. Dimensional clustering can enable edge detection in images even in the absence of any clearly-defined dynamical generating process.

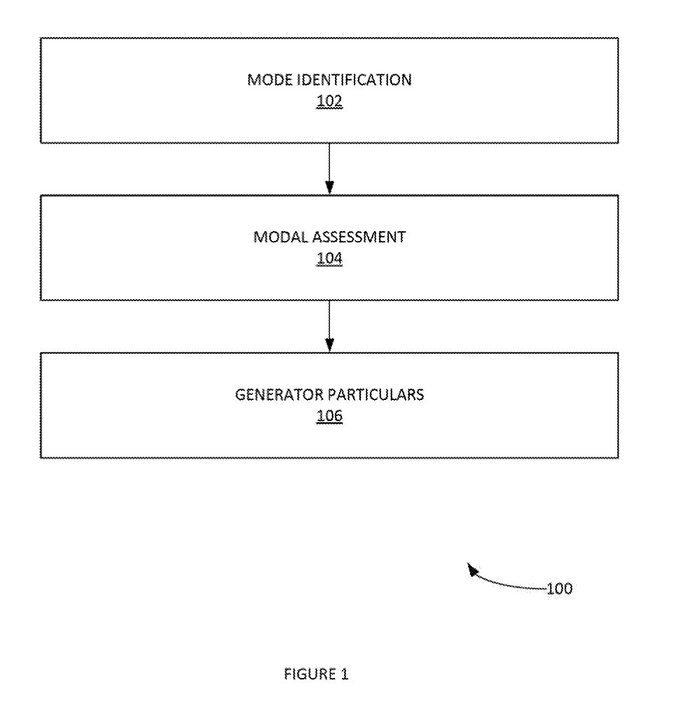

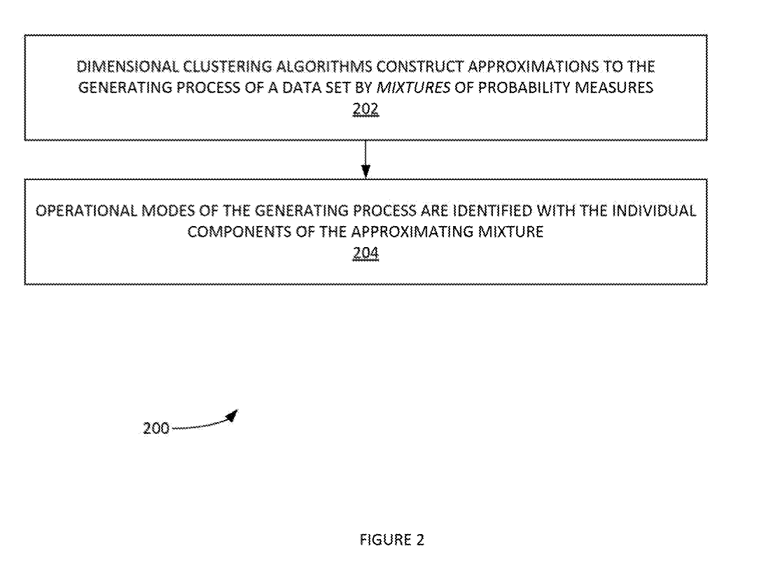

More particularly, FIG. 1 illustrates a process 100 of dimensional clustering, according to some embodiments. In step 102, process 100 implements mode identification. FIG. 2 illustrates an example process 200 of mode identification, according to some embodiments. In step 202, dimensional clustering algorithms can construct approximations to the generating process of a data set by mixtures of probability measures. In step 204, the operational modes of the generating process are identified with the individual components of the approximating mixture. It is noted that, in some examples, in order to identify these components, the process 200 can make use of dimensional characteristics of the generating process. For example, the estimated pointwise dimension of the generating process at each of the points in the input data set can be determined. Additionally, distinct components can exhibit distinct pointwise dimensional characteristics. The input into process 200 can be a data set consisting of points generated by a process which may have several different latent modes of operation. The output of process 200 can be the estimated modes of operation of the generating process.

An example use case of process 200 is now provided. Alice is a registered user of a certain online book store. She frequently goes to their website to explore it in the search of new reading material, to read reviews of books that she is considering for purchase, to see if they have any new offers that might save her some money, and to actually place orders for books that she has decided to buy. The book store has access to the history of Alice's page views on their website (e.g. which pages she has requested from their servers, and the date and time at which each request was made, etc.). This is the data that they are working with. The generating process in this situation is Alice herself. Her reasons, listed earlier, for visiting the website suggest what kind of modes may exist in the generation of her page view data. The way she generates page views when she is exploring the website for new material differs from the way in which she generates page views when she is reading reviews with the intention of actually making a purchase, or when she is looking for a bargain.

In this situation, a dimensional clustering analysis identifies that there are three distinct behavioral modes latent to Alice as a page view generator on this website. These modes are identified by their dimensional characteristics. The algorithm at this stage is not aware exactly what each mode represents in the context of Alice's desires. The raw modes identified above are given contextual meaning by using them to assess data previously generated by Alice and then relating these assessments to other data, which provide the semantic context within which the identified modes may be understood as expressing Alice's intentions. If Alice's page views which are assessed to have been most likely generated while Alice was in the first of the three identified modes always occur right before Alice makes a purchase, then it is clear that the first mode signifies intent to purchase. Similarly, if the page views assessed to have been most likely generated under the second identified mode of operation occur when Alice is viewing books in genres that Alice rarely views, then the second mode most likely signifies intent to explore.

Having associated modes with intention in this manner, the online book store may now predict what Alice is looking for in real time, using the data she generates as she interacts with the website. They would use these predictions to deliver to her the content she actually wants (in an unobtrusive manner, preferably) without her having to ask them for it. This effectively smoothens her interface to their catalogue.

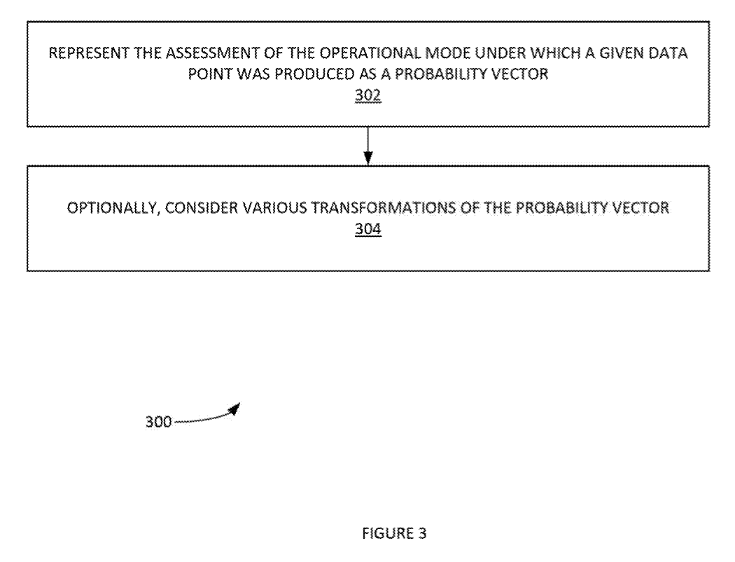

Returning to process 100, in step 104, process 100 implements modal assessment. FIG. 3 illustrates an example process 300 modal assessment, according to some embodiments. In step 302, given a mixture distribution representing the modes of operation of a generating process, one may represent the assessment of the operational mode under which a given data point was produced as a probability vector (e.g. a likelihood vector). Each component of the probability vector can represent the relative certainty with which the data point could be said to have been generated by the corresponding mode. Such an assessment can be computed, for example, by normalizing the vector of likelihoods of the point having been generated by each of the individual components.

The above is simply one example of a scheme which could be employed for mode assessment. Many variations are possible on this theme. For example, optionally in step 304, process 300 can implement various transformations of the probability vector. In another example, process 300 can employ different notions of likelihood as well. One particularly useful variant is to transform the vector of likelihoods by placing a one (1) in the coordinate of maximal value and zeroing out all the other entries. The input into process 300 can be a single point of data produced by a certain generating process, and the modes of operation of that generating process. The output of process 300 can be a single point of data produced by a certain generating process, and the modes of operation of that generating process.

An example use case of process 300 is now provided. In reality, the way that Alice browses the online book store's website may change over time in the sense that she may adopt new modes under which she interacts with the site, and she may stop operating under modes that she currently employs. This kind of change in modes may be identified using dimensional clustering by applying the mode identification procedure on new data points even as they are being assessed in the context of previously identified modes. Updating the estimated modes in this manner makes predictive techniques derived from this information robust to even very sudden changes in Alice's behavior in relation to the online book seller.

This technique also suggests that the estimated modes may themselves be used as identifiers rather than simply as a means of constructing modal assessments. For example, given an up-to-date estimate of Alice's browsing modes, this estimate might be very close in the relevant mathematical space of possible estimates to the modes estimated for another user, Bob, a year ago. The online book store, knowing how its interactions with Bob affected his engagement with its website over the past year, can then repeat with Alice what was successful with Bob while avoiding the actions disruptive to his engagement.

This idea can be generalized to any data generator. For example, the estimated modes for a generating process at a given point in time may constitute a modal signature for that process. Similar a set of modal signatures can indicate similar patterns of behavior, and vice versa.

To really see the power of this idea, suppose a user has a video of someone performing a particular dance and the user would like to find music that it would be appropriate to perform that dance to. If the user had a large repository of candidate audio with estimated modal signatures for each file in the repository, all the user would have to do is compute the modal signature of the dance performance in the video and match it with the audio file with the modal signature closest to it. This would allow the user to create a search engine which doesn't allow the user to search through just textual data, but rather data in any format—video matching a given audio sample, videos similar to a given video sample, audio similar to a given pressure profile input through a touch screen, etc. As sensor technology progresses, the data from new sensors could easily be integrated into such an engine through the construction of modal signatures. Such an engine could even incorporate the senses of smell and taste, and perhaps even emotions.

Returning to process 100, in step 106, process 100 can implement various generator particulars. Dimensional clustering can approximate data generators using mixtures of probability distributions. However, it is noted that, in some embodiments, there is no requirement that any generator to which a dimensional clustering algorithm is being applied actually be a mixture of probability distributions. As such, dimensional clustering may be employed in identifying the operational modes of almost any generator of data and assessing how dominant each of these modes was in the generation of a given data point.

Exemplary Systems and Architecture

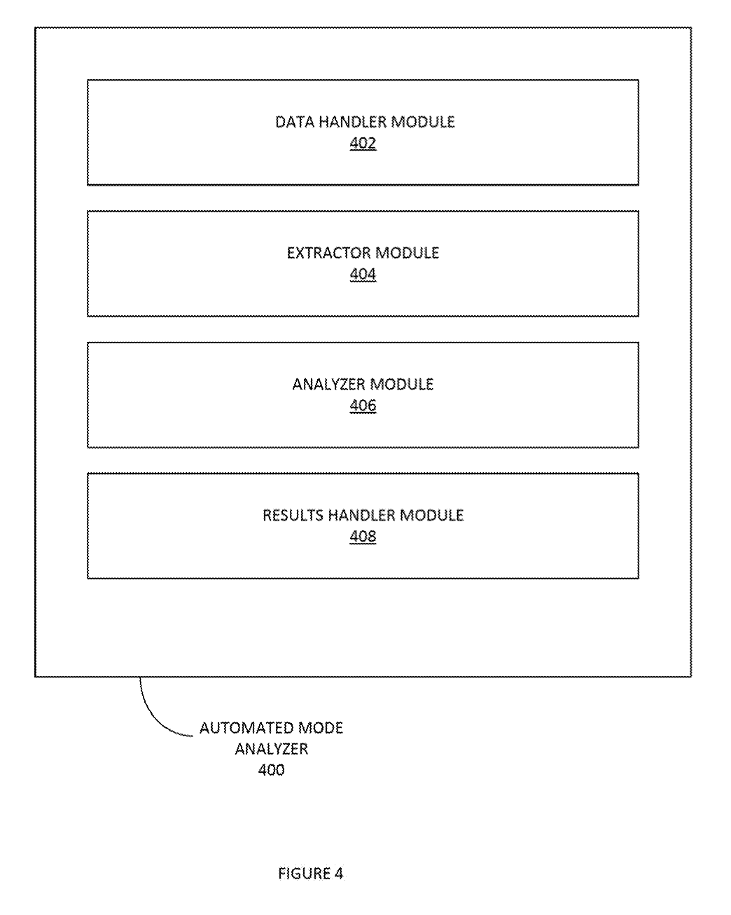

FIG. 4 depicts an exemplary automated mode analyzer 400 that can be configured to perform any one of the processes provided herein. Automated mode analyzer 400 can use dimensional clustering to identify and make use of the operational modes of a given source of data.

In one example, automated mode analyzer 400 can accept data from a single source. Automated mode analyzer 400 can use a selection of this data to build a modal profile of the source. Automated mode analyzer 400 can use a modal profile of the source to predict the mode under which a given data point was generated by the source. In another example, automated mode analyzer 400 can also, in addition to providing this basic functionality, manage data from multiple sources. An automated mode analyzer 400 can use various statistics pertaining to the data source to create contexts under which to interpret its modal profiles and predictions.

An example of developing a modal profile is now provided. Automated mode analyzer 400 can develop a modal profile(s) from a sample of data by deriving metric properties of each data point in relation to the other data points in the sample. Automated mode analyzer 400 can then use these derived metric properties to construct a probability distribution which represents the modal profile. Modal predictions are generated by estimating the probability that a given data point was generated by each of the components of a mixture distribution representing a given modal profile.

In one example embodiment, automated mode analyzer 400 can include various components as shown in FIG. 4. Data handler module 402 can accepts data. Data handler 402 can include rules that dictate which data is to be used for the generation of modal profiles and which data is to be subjected to modal predictions (e.g. these conditions are not exclusive). Extractor module 404 can derives the relevant metric properties of that data point in relation to the designated contextual data sample according to a scheme which may vary from extractor to extractor. Analyzer module 406 can use the extracted metric properties to build modal profiles and generate modal predictions. Results handler 408 can manage the results of the analyses requested from the system until they are required and/or until they can be discarded. This example framework may be extended in more complex automated mode analyzer 400 (e.g. by adding components into the work flow either prior to the data handler and/or subsequent to the results handler module 408).

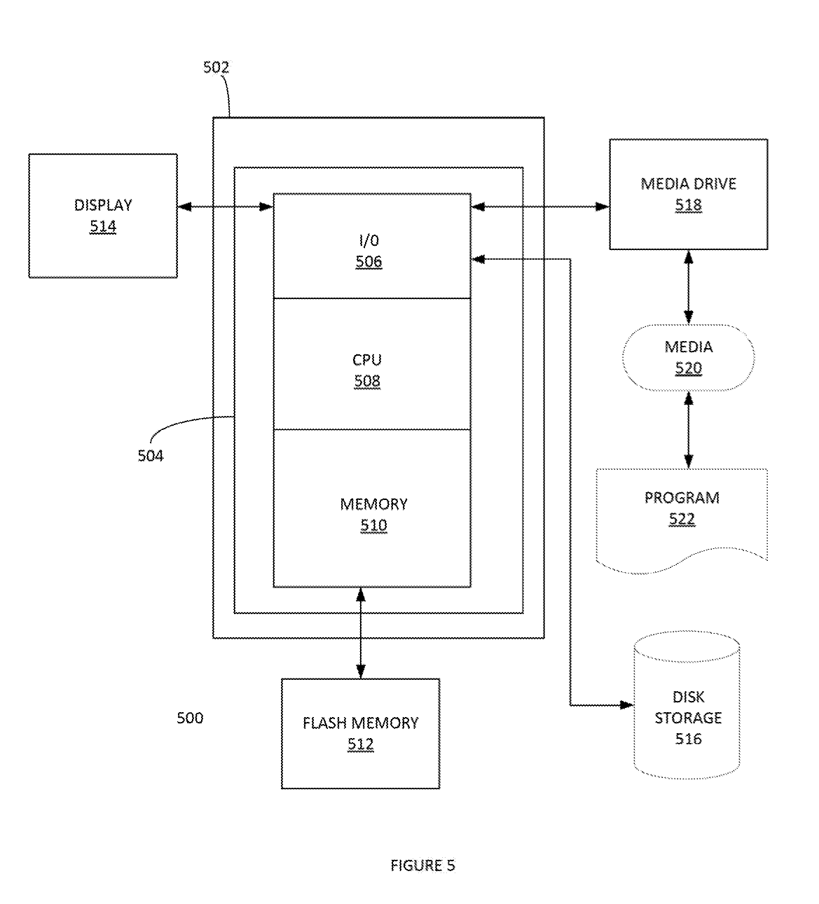

FIG. 5 depicts an exemplary computing system 500 that can be configured to perform any one of the processes provided herein. In this context, computing system 500 may include, for example, a processor, memory, storage, and I/O devices (e.g. monitor, keyboard, disk drive, Internet connection, etc.). However, computing system 500 may include circuitry or other specialized hardware for carrying out some or all aspects of the processes, in some operational settings, computing system 500 may be configured as a system that includes one or more units, each of which is configured to carry out some aspects of the processes either in software, hardware, or some combination thereof.

FIG. 5 depicts computing system 500 with a number of components that may be used to perform any of the processes described herein. The main system 502 includes a motherboard 504 having an I/O section 506, one or more central processing units (CPU) 508, and a memory section 510, which may have a flash memory card 512 related to it. The I/O section 506 can be connected to a display 514, a keyboard and/or other user input (not shown), a disk storage unit 516, and a media drive unit 518. The media drive unit 518 can read/write a computer-readable medium 520, which can contain programs 522 and/or data. Computing system 500 can include a web browser. Moreover, it is noted that computing system 500 can be configured to include additional systems in order to fulfill various functionalities. Computing system 500 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

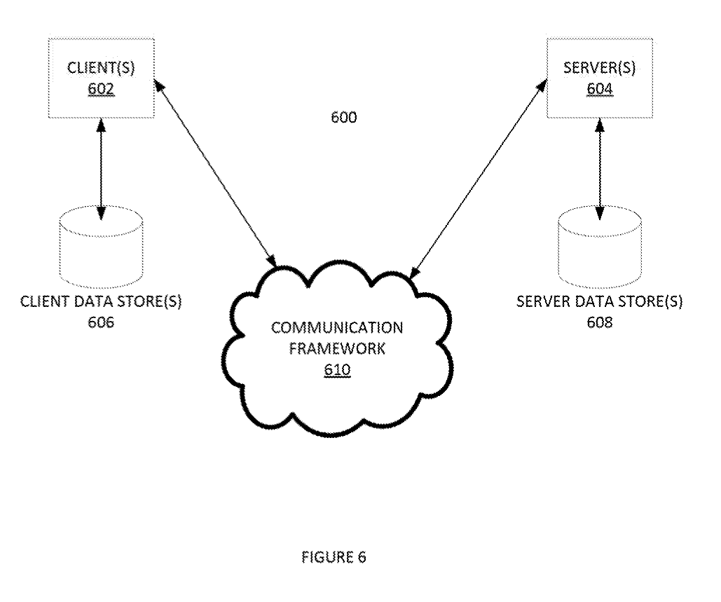

FIG. 6 is a block diagram of a sample computing environment 600 that can be utilized to implement various embodiments. The system 600 further illustrates a system that includes one or more client(s) 602. The client(s) 602 can be hardware and/or software (e.g. threads, processes, computing devices). The system 600 also includes one or more server(s) 604. The server(s) 604 can also be hardware and/or software (e.g. threads, processes, computing devices). One possible communication between a client 602 and a server 604 may be in the form of a data packet adapted to be transmitted between two or more computer processes. The system 600 includes a communication framework 610 that can be employed to facilitate communications between the client(s) 602 and the server(s) 604. The client(s) 602 are connected to one or more client data store(s) 606 that can be employed to store information local to the client(s) 602. Similarly, the server(s) 604 are connected to one or more server data store(s) 508 that can be employed to store information local to the server(s) 604.

It is noted that clustering a data set can include defining a collection of distinct categories and then specifying the likelihood with which each point in the data set belongs to each of the distinct categories. Classifying a data point with respect to a set of clusters can include specifying the likelihood with which the data point can be associated with each of the clusters in the set of clusters. A dynamic process can be a process which generates numerical data points, possibly in relation to certain input parameters, according to some pre-specified, deterministic set of rules.

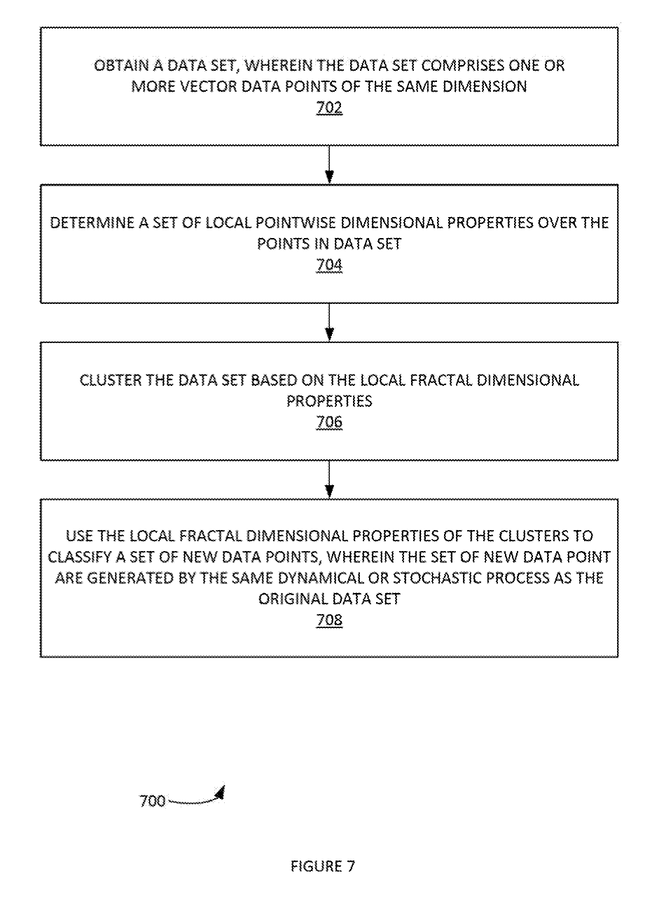

FIG. 7 illustrates an example process 700 for increasing the speed of processing clustered data, according to some embodiments. In step 702, process 700 can obtain a data set. The data set comprises one or more vector data points of the same dimension. In step 704, process 700 can determine a set of local pointwise dimensional properties over the points in data set. In step 706, process 700 can cluster the data set based on the local fractal dimensional properties. In step 708, process 700 can use the local fractal dimensional properties of the clusters to classify a set of new data points. The set of new data point are generated by the same dynamical or stochastic process as the original data set.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g. embodied in a machine-readable medium).

In addition, it can be appreciated that the various operations, processes, and methods disclosed herein can be embodied in a machine-readable medium and/or a machine accessible medium compatible with a data processing system (e.g. a computer system), and can be performed in any order (e.g. including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method useful for increasing the speed of processing clustered data comprising:
obtaining a data set, wherein the data set comprises one or more vector data points of the same dimension;
determining a set of local pointwise dimensional properties over the points in data set;
clustering the data set based on the local fractal dimensional properties;
using the local fractal dimensional properties of the clusters to classify a set of new data points, wherein the set of new data point are generated by the same dynamical or stochastic process as the original data set.

2. The method of claim 1 further comprising:
identifying a set of distinct behavioral components of the dynamic or stochastic processes which generated the data set.

3. The method of claim 2, wherein the clusters are modeled as being generated by exponential distribution.
